(19) United States
(12) Patent Application Publication
(10) Pub. No.: US 2021/0402681 A1
(43) Pub. Date: Dec. 30, 2021

(54) ADJUSTMENTS BASED ON THE AGE OF FUSING AGENTS

(71) Applicant: HEWLETT-PACKARD DEVELOPMENT COMPANY, L.P., Spring, TX (US)

(72) Inventors: Xin Cheng, Vancouver, WA (US); Vanessa Verzwyvelt, Vancouver, WA (US); Miguel Angel Lopez Alverez, Vancouver, WA (US); Morgan T Schramm, Vancouver, WA (US); James D. Plymale, Vancouver, WA (US); Jeffrey Wagner, Vancouver, WA (US); Michael Crockett, Vancouver, WA (US)

(21) Appl. No.: 16/605,283

(22) PCT Filed: Jul. 27, 2018
(86) PCT No.: PCT/US2018/044003

§ 371 Date: Oct. 15, 2019

(51) Int. Cl. B29C 64/165; B29C 64/393

(52) U.S. Cl. CPC B29C 64/165; B33Y 10/00; B29C 64/393

(57) ABSTRACT

In example implementations, an apparatus is provided. The apparatus includes a dispense element, a memory, and a processor. The dispense element dispense a fusing agent onto a build material. The memory stores an absorption level decay data of the fusing agent and at least one adjustment recipe. The processor is communicatively coupled to the dispense element, and the memory. The processor controls the dispense element to dispense the fusing agent based on an adjustment recipe of the at least one adjustment recipe that is selected. The adjustment recipe is selected based on an absorption level determined from the absorption level decay data and an age of the fusing agent.

### BACKGROUND

Three dimensional (3D) printers can be used for additive printing. The three dimensional printers can create three dimensional (3D) objects via the additive printing process. For example, a layer of build material, such as a powder or powder-like build material, can be formed on a build platform. A fusing agent can be selectively sprayed, for example using a printhead, onto the powder in desired locations (e.g., locations that correspond to areas of the object that will be printed). Energy can be applied to the formed layer causing those portions of the layer on which fusing agent was applied to heat up and melt, sinter, or otherwise coalesce. The process can then be repeated for each layer until printing of the 3D object is completed.

### BRIEF DESCRIPTION OF THE DRAWINGS

FIG. 1 is a block diagram of an example three-dimensional printer of the present disclosure;

FIG. 2 is a block diagram of an example of an apparatus of the three-dimensional printer that controls an adjustment based on an age of a fusing agent of the present disclosure;

FIG. 3 is an example of an absorption level decay data of a fusing agent;

FIG. 4 is a flow chart of an example method for adjusting an amount of color agents based on an age of a fusing agent; and

FIG. 5 is a block diagram of an example non-transitory computer readable storage medium storing instructions executed by a processor to adjust an amount of color agents based on an age of a fusing agent.

### DETAILED DESCRIPTION

Examples described herein provide a three dimensional (3D) printer and method for adjusting amounts of the fusing agent and/or color agents based on an age of a fusing agent. As discussed above, some 3D printers may use a fusing agent to melt powder at desired locations to print the 3D object. The combination of the color agents and the fusing agent can contribute to the thermal needs during the printing process. For example, the type and amount of fusing agent and the type and amount of color agents that are dispensed may vary the thermal needs of a particular print job. For example, different types of fusing agents and different types of color agents may have different energy absorption levels.

The absorption level of the fusing agent may refer to the ability of the fusing agent to absorb energy. In an example, the fusing agents may work with a fusing lamp in the 3D printer. The absorption level of the fusing agent may be the ability to absorb the electromagnetic spectrum emitted by the fusing lamp.

The absorption levels of some fusing agents can decay over time. In other words, as the fusing agent ages, the absorption levels (e.g., the absorbency of the electromagnetic spectrum emitted by the fusing lamp) may fall and gradually level off. As the absorption levels fall, the ability of the fusing agent to absorb energy to heat, melt, and fuse the powder can be reduced.

Examples herein provide a method that adjusts the amount of fusing agent and/or color agents for a particular color that are applied at locations on a layer of build material that corresponds to voxels of a 3D object model, based on an age of the fusing agent. A voxel may be a location of a 3D object to be printed in the digital domain. The voxel may correspond to a location or a sub-voxel on the build material during printing of the 3D object.

The absorption level decay over time can be plotted for a fusing agent of the 3D printer and stored in memory. For up to certain amounts of the fusing agent, an adjustment recipe may be selected to adjust the amount of fusing agent that is added based on the age of the fusing agent and the absorption level determined from the absorption level decay data.

However, if too much fusing agent is added, the fusing agent may actually begin to have a cooling effect on the build material. Therefore, the adjustment recipe may adjust the amount of color agents that are dispensed onto the build material to compensate for the reduction of absorption level of the fusing agent. A color agent recipe for different colors at each absorption level can also be stored in memory. Thus, based on the age of the fusing agent, an appropriate adjustment to the fusing agent or the color agents can be made to compensate for the reduction of the absorption level of the fusing agent.

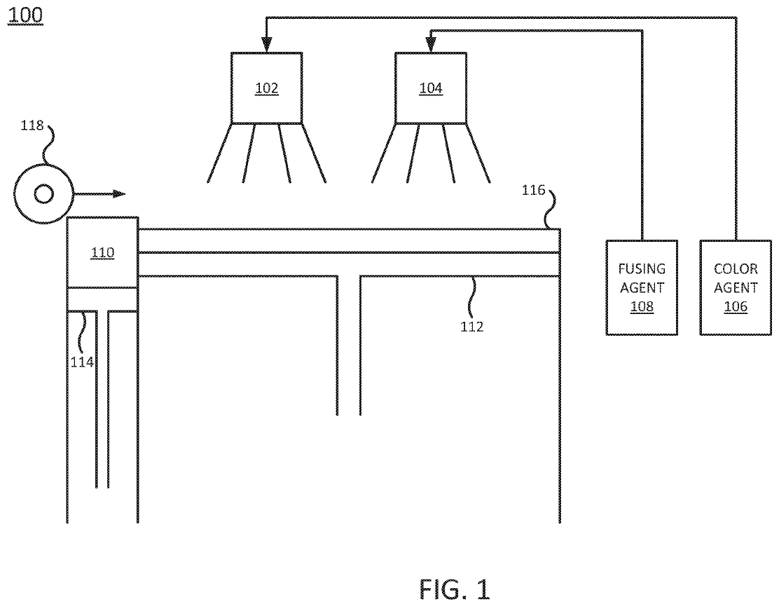

FIG. 1 illustrates a block diagram of a three dimensional (3D) printer 100 of the present disclosure. In one example, the 3D printer 100 may include a build material dispenser 114 that dispenses a build material 110 onto a build material bed 112. In one example, the build material dispenser 114 may push an amount of the build material 110 above the build material bed 112 or a previous layer 116 of the build material 110. A recoater 118 (e.g., a roller or a wiper mechanism) may spread the build material 110 onto the build material bed 112 or the previous layer 116 of the build material 110 to form a subsequent layer. The build material bed 112 may move lower as each level of the build material 110 is printed. The build material 110 may be any type of metallic or plastic based powder that can be used for additive printing.

In one example, dispense elements 102 and 104 may dispense a color agent 106 and a fusing agent 108, respectively. Although two dispense elements 102 and 104 are illustrated in FIG. 1, it should be noted that the dispense elements 102 and 104 may be combined into a single dispense element. In one example, more than two dispense elements may be deployed. For example, if multiple different fusing agents are dispensed, a dispense element for each fusing agent may be deployed. Additionally, if multiple different color agents 106 are dispensed, a dispense element for each color may be deployed.

In one example, the fusing agent 108 may be dispensed onto the build material 110 in a desired pattern to print a layer on the build material 110. The whole of the formed layer of build material 110 may be exposed to a radiation source such as an infrared energy, or near infrared energy. The portions of the build material 110 on which the fusing agent 108 is applied absorb more of the radiation than portions on which no fusing agent 108 is applied. As the fusing agent 108 absorbs the infrared light, the temperature of the fusing agent 108 may rise to melt the build material 110 in the printed locations.

The fusing agent 108 may be any type of fusing agent that has the absorption levels decay as the fusing agent ages. An example of the fusing agent 108 may be a fusing agent that is mostly clear in the visible spectrum, but also absorbent in the infrared spectrum. In other words, the fusing agent 108 may not absorb energy in the visible spectrum, but may absorb large amounts of infrared energy. The fusing agent 108 may be mostly clear, but have some light-blue tint.

In one example, the fusing agent 108 may contain a plasmonic resonance absorber and have absorption at wavelengths ranging from 800 nanometers (nm) to 4000 nm and transparency at wavelengths ranging from 400 nm to 780 nm. The plasmonic resonance absorber may be an inorganic pigment having an average particle diameter ranging from about 10 nm to 200 nm. Examples of suitable inorganic pigments may include lanthanum hexaboride (LaB₆), tungsten bronzes (AₓWO₃) (including alkali doped tungsten oxides), indium tin oxide (In₂O₃:SnO₂, ITO), aluminum zinc oxide (AXO), ruthenium oxide (RuO₂), silver (Ag), gold (Au), platinum (Pt), iron pyroxenes (AₓFe_{y}Si₂O₆, wherein A is calcium or magnesium, x=1.5-1.9, and y=0.1-0.5), modified iron phosphates (AₓFe_{y}PO₄), modified copper pyrophosphates (AₓCu_{y}P₂O₇), and the like. Combinations of the inorganic pigments may also be used.

The amount of the plasmonic resonance absorber that is present in the fusing agent 108 may range from about 1.0 weight percent (wt %) to about 20.0 wt % based on the total weight of the fusing agent 108. In another example, the amount of plasmonic absorber in the fusing agent 108 may range from about 1.0 wt % to about 10.0 wt %. In another example, the amount of plasmonic resonance absorber in the fusing agent 108 may range from greater than 4.0 wt % to about 15.0 wt %.

The plasmonic resonance absorber may be contained in a liquid vehicle for the fusing agent 108. The vehicle may be aqueous or non-aqueous vehicles. Example vehicles for the plasmonic resonance absorber may include water alone, or a non-aqueous solvent alone (e.g., dimethyl sulfoxide (DMSO), ethanol, and the like). The vehicle may also include a dispersing additive, a surfactant, a co-solvent, a biocide, an anti-kogation agent, a silane coupling agent, a chelating agent, or any combinations thereof.

In one example, absorption may be defined as absorbing 80% or more of the radiation having wavelengths ranging from 800 nm to 4000 nm. In one example, transparency may be defined as absorbing 20% or less of radiation having wavelengths ranging from 400 nm to 780 nm. This type of mostly clear fusing agent that is absorbent in the infrared spectrum, but does not absorb energy in the visible spectrum may be referred to as a low tint fusing agent (LTFA).

In one example, the color agent 106 may be applied to different locations on the build material 110 in addition to the locations that receive the fusing agent 108. The color agent 106 may add color to different voxel locations of the 3D object that is printed by the 3D printer 100. The color agent 106 may be added to surface locations (e.g., voxel locations that are not in the core of the 3D object and that cannot be seen in the 3D printed object). In one example, different color agents 106 may be dispensed in desired amounts to generate a specific color at a voxel location. For example, the color agents 106 may include a cyan color agent, a yellow color agent, a magenta color agent, and a black color agent.

In one example, the color agent 106 may also have an associated absorption level. As discussed in further details below, the amount of color agent 106 that is dispensed may also be adjusted to compensate for the decay in the absorption level of the fusing agent 108 as the fusing agent 108 ages.

It should be noted that FIG. 1 has been simplified for ease of explanation. For example, the 3D printer 100 may include additional components that are not shown. For example, the 3D printer 100 may also include a controller to control the dispense elements 102 and 104, the movement of the build material dispenser 114, and the build material bed 112. The 3D printer 100 may also include an infrared light source.

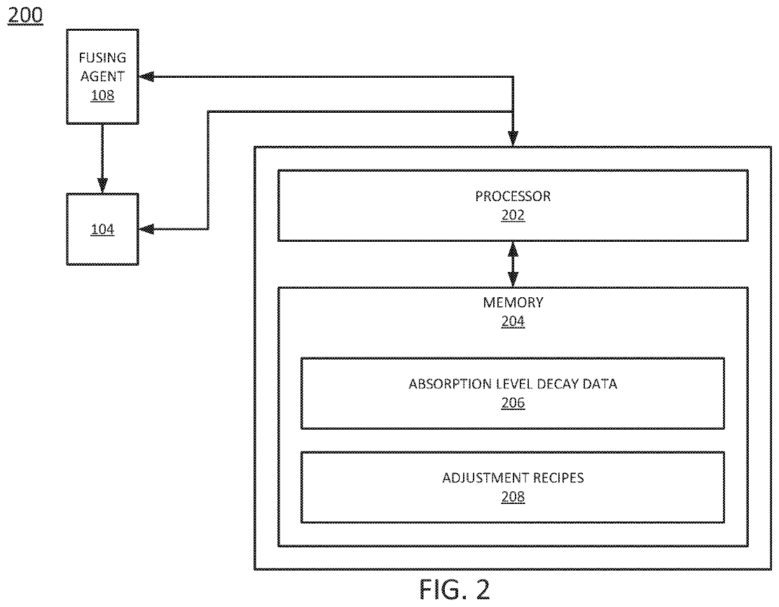

FIG. 2 illustrates an example of an apparatus 200 that may be part of the 3D printer 100. In one example, the apparatus 200 may include the dispense element 104 that may dispense the fusing agent 108. In one example, the dispense element 104 may also be used to dispense the color agent 106 or a plurality of different color agents 106, as discussed above in FIG. 1.

In one example, the apparatus 200 may also include a processor 202 and a memory 204. The processor 202 may be communicatively coupled to the memory 204. The processor 202 may also be communicatively coupled to the dispense element 104 to control the dispense element 104 to dispense the fusing agent 108.

The memory 204 may be a non-transitory computer readable memory. For example, the memory 204 may be random access memory (RAM), a read-only memory (ROM), a hard disk drive, and the like. In one example, the memory 204 may store an absorption level decay data 206 and adjustment recipes 208.

As discussed above, as the fusing agent 108 ages, the absorption level in the electromagnetic range of energy emitted by a fusing lamp of the fusing agent 108 may also decay. In some instances, the absorption level may decay relatively quickly after its manufacture. As a result, the same amount of fusing agent 108 for a particular build material 110 may not be sufficient to melt the build material 110 depending on the age of the fusing agent 108.

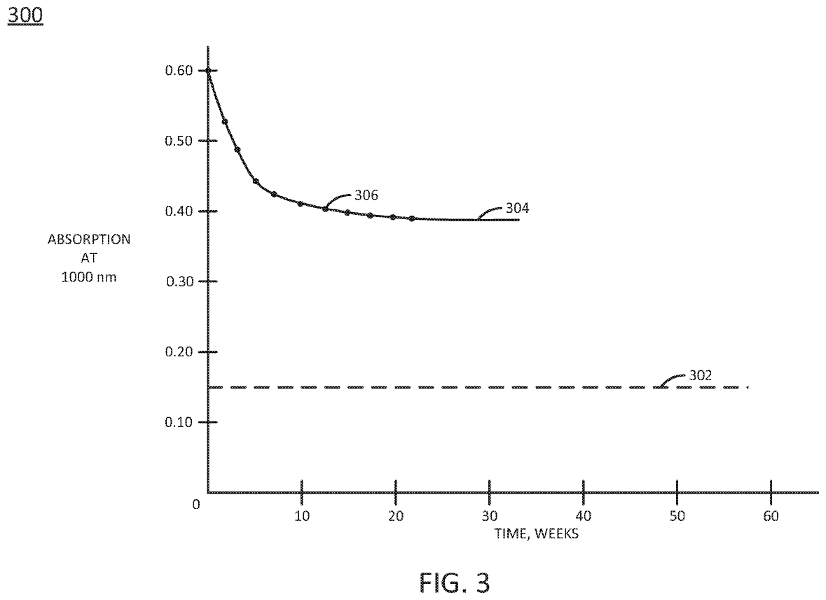

FIG. 3 illustrates an example absorption level decay graph 300 of the fusing agent 108. The graph 300 may include an x-axis that represents time (e.g., in weeks) and the y-axis may represent absorption at 1000 nanometers (nm) for the fusing agent 108. The absorption level decay graph 300 illustrates a data 304 that is an example of how the absorption level of the fusing agent 108 may decay over time. The data 304 may look different for different types of fusing agents 108 and different absorption spectra. The graph 300 may be plotted before the 3D printer 100 or the apparatus 200 is deployed, for example based on experimental studies.

In one example, the graph 300 illustrates a level 302 where absorption levels below the level 302 may not be sufficient. Notably, the data 304 is above the level 302. The data 304 illustrates a point 306 where the absorption level begins to level off as time increases. For example, “leveling off” may be defined as having subsequent data points that have a difference less than a threshold (e.g., differences of less than 0.05 nm) Thus, the compensation for the absorption level decay may be discontinued once the age of the fusing agent 108 reaches the point 306. In other words, the amount of fusing agent 108 or the amount of color agents 106 may remain constant after the fusing agent 108 reaches the age associated with the point 306.

Referring back to FIG. 2, the memory 204 may store the absorption level decay data 206 and the adjustment recipes 208. In one example, the adjustment recipes 208 may include changes to an amount of the fusing agent 108 and/or the color agent 106 that should be dispensed at a particular voxel location based on the age of the fusing agent 108 and the absorption level of the fusing agent 108 obtained from the absorption level decay data 206.

In one example, the adjustment recipes 208 may change the amount of fusing agent 108 to compensate for the absorption level decay of the fusing agent 108. The adjustment recipes 208 may be used in addition to data derived from a 3D object model that defines the 3D object to be printed and a color for a particular location that is printed to determine an amount of fusing agent 108 that may be dispensed at the location. The data derived from the 3D object model may include data generated by a computing system before the 3D object is printed by the 3D printer 100. The data may be related to locations in a layer 116 of the build material 110 that are to be “printed” to form the 3D object.

In one example, additional fusing agent 108 may be added up to a certain amount. In an example, the additional amount of fusing agent 108 may be added in increments of a discrete number of drops. In an example, the additional amount of fusing agent 108 may be added by changing a size of the dispensed drops (e.g., using piezo printhead technology). In an example, the additional amount of fusing agent 108 may be added by a combination of changing a number of drops and a size of the drops. As noted above, when too much fusing agent 108 is added, the fusing agent 108 may have a cooling effect on the build material 110.

For example, when a graph of the amount of fusing agent 108 is plotted against a temperature obtained, the graph may initially show a rise in temperature as more fusing agent 108 is added. After a certain point, the temperature may plateau or level off even as more fusing agent 108 is added. At a later point, when too much fusing agent 108 is added, the temperature may begin to fall.

In one example, the adjustment recipes 208 may include recipes to adjust an amount of the fusing agent 108 to compensate for thermal drifts up to, in one example, about 3 degrees Celsius (° C.). The amount where the fusing agent 108 begins to act as a cooling agent may vary based on the type of fusing agent 108 that is used. For the example of a particular type of fusing agent 108, the maximum amount may range between a first volume or fill percentage value (e.g., 12 percent of the total volume) when the fusing agent 108 is newly dispensed (e.g., age=0) up to a second volume or fill percentage value that is higher than the first volume or fill percentage value (e.g., 49 percent of the total volume) when the fusing agent 108 is 6 weeks old.

In one example, the adjustment recipes 208 may also include recipes to adjust an amount of the color agents 106 that are dispensed. As noted above, adding too much fusing agent 108 can have a cooling effect on the build material and fusing temperature. Thus, when the age of the fusing agent is below an age threshold and an adjustment amount of the fusing agent is above a fusing agent amount threshold, the adjustment recipe 208 may include adjustments to the amount of color agents 106 that are dispensed.

In one example, larger amounts of color agents 106 used to produce a color at a given location may be dispensed in the first few weeks of life of the fusing agent 108. As the fusing agent 108 ages, the amount of color agents 106 may be increased or decreased, depending on the effect of a particular color agent, to reduce the effect on fusing temperature due to the lower absorption levels of the aged fusing agent 108.

In one example, an adjustment recipe of the color agents may indicate how much of each color agent to adjust based on a color to be printed at a particular voxel location. For example, if the color agents include a cyan color agent, a yellow color agent, a magenta color agent, and a black color agent, the adjustment recipe may adjust the amount of the cyan color agent, the yellow color agent, the magenta color agent, and the black color agent.

In one example, the adjustment may be to increase or decrease the amount of the color agent that is dispensed. For example, some color agents (e.g., cyan and black color agents) may help to reach a fusing temperature and may be increased to help the aging fusing agent 108. Some color agents (e.g., yellow color agents) may harm the ability to reach the fusing temperature and may be decreased.

The amount of the color agent that is added in addition to the fusing agent 108, as the fusing agent 108 ages, may be managed based on the color that is to be printed and the thermal profile of the color agents used to create the color. For example, if a color at a particular location includes a black color agent and a cyan color agent, additional amounts of the black color agent and/or the cyan color agent can be added to help offset the aged fusing agent 108. If a color a particular location includes a yellow color agent, a lower amount of the yellow color agent can be added to mitigate the cooling effect of the yellow color agent. In other words, each color for a particular location may be associated with a CMYK formula and depending on the formula and the age of the fusing agent 108, the formula may be modulated to compensate for the reduction of the absorption levels of the fusing agent 108 based on the age of the fusing agent 108.

In one example, the adjustment recipes 208 may include an adjustment recipe for each color that can be printed by the 3D printer 100 using the color agents. In another example, the adjustment recipes 208 may include an adjustment recipe for a subset of colors that can be printed by the 3D printer 100. When a color is selected that does not have an associated adjustment recipe 208, the adjustment recipe for the color to be printed may be interpolated. For example, the adjustment recipe can be interpolated from existing adjustment recipes using, for example, a variety of standard interpolation methods.

The adjustment recipe can be interpolated using any number of existing adjustment recipes. For example, the adjustment recipes for two colors (e.g., the closest color that is lighter than the color to be printed and the closest color that is darker than the color to be printed) may be identified. The adjustment recipe for the color to be printed may be interpolated to determine an adjusted amount of the color agents to dispense to generate the color based on the adjustment recipe 208 of two colors. In another example, the adjustment recipe for the color to be printed may be interpolated based on a single adjustment recipe 208 of a closest color that is stored in the memory 204.

In one example, the adjustment recipes 208 may be applied when the age of the fusing agent 108 is below an age threshold. For example, after a certain age, the absorption level decay may begin to level off (e.g., the point 306 illustrated in FIG. 3). As a result, a set amount of the fusing agent 108 and/or the color agents 106 may be used after the age of the fusing agent 108 exceeds the age threshold. The age threshold may correspond to the time associated with the point 306 illustrated in FIG. 3.

In one example, the amount of adjustment indicated by the adjustment recipes 208 may be relative to the set amounts used after the age of the fusing agent 108 has exceeded the age threshold. In other words, the amount of adjustment to the fusing agent 108 and/or the color agents 106 indicated by the adjustment recipes 208 may be based on a difference between the calculated amounts to dispense and the set amounts dispensed when the age of the fusing agent 108 has exceeded the age threshold.

In one example, the adjustment recipes 208 may simply indicate the amount of fusing agent 108 and/or color agents 106 to dispense based on the age of the fusing agent 108 and the absorption level of the fusing agent 108 at the calculated age. For example, the adjustments may be calculated and applied in advance as part of the adjustment recipes 208 to determine the dispensing amounts of the fusing agent 108 and/or the color agents 106.

In one example, the exact values of the adjustment amounts may vary based on the type of fusing agent 108 that is used and the type of color agents 106 that are used. The adjustment recipes 208 may be created before the 3D printer 100 is deployed based on the fusing agent 108 and the color agents 106 that may be used for the 3D printer 100.

In one example, the adjustment recipe 208 may be selected for each voxel location of a 3D object that is to be printed on the 3D printer 100. For example, different voxel locations of the 3D object may be printed in different colors. As a result, the adjustment recipe 208 may be selected based on the color that is to be printed at each voxel location.

In one example, the adjustment recipe 208 may be selected for each voxel location before the 3D printer 100 begins printing the 3D object. For example, the processor 202 may select the adjustment recipe 208 for each voxel location based on the age of the fusing agent 108, the absorption level of the fusing agent 108 at the current age obtained from the absorption level decay data 206, and a color which is to be printed. The processor 202 may store the selected adjustment recipes 208 in the memory 204. The processor 202 may then control the dispense element 104 (and the dispense element 102) to dispense the compensated/adjusted amounts of the fusing agent 108, and/or the color agents 106, on the build material 110 based on the stored selected adjustment recipes 208 for a particular print job.

In one example, the age of the fusing agent 108 may be calculated when the fusing agent 108 is newly supplied to the 3D printer 100. For example, when a storage container of the fusing agent 108 is empty and refilled, the age of the fusing agent 108 may be determined to be zero. The processor 202 may calculate the age of the fusing agent 108 based on a current time relative to the time the storage container was filled with new fusing agent 108. In another example, the processor 202 may calculate the age of the fusing agent 108 using a timer that runs once the storage container is refilled with the fusing agent 108.

In another example, the age of the fusing agent 108 may be calculated in real-time for each print job. For example, the date and time the fusing agent 108 was dispensed into the storage container may be stored in the memory 204. Each time a new print job is submitted to the 3D printer 100, the processor 202 may calculate the age of the fusing agent 108. Based on the age of the fusing agent 108, the processor 202 may determine the absorption level of the fusing agent 108 using the absorption level decay data 206. The processor 202 may then select an adjustment recipe for the determined absorption level.

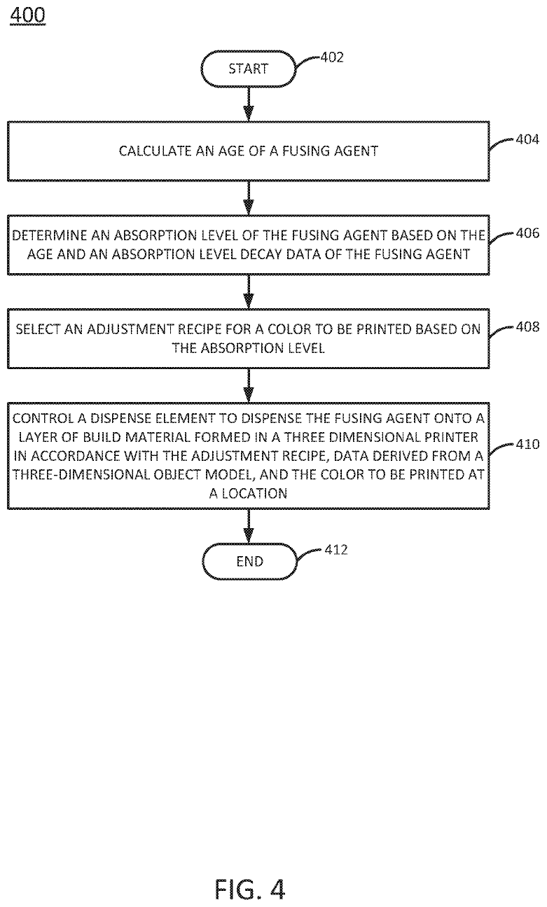

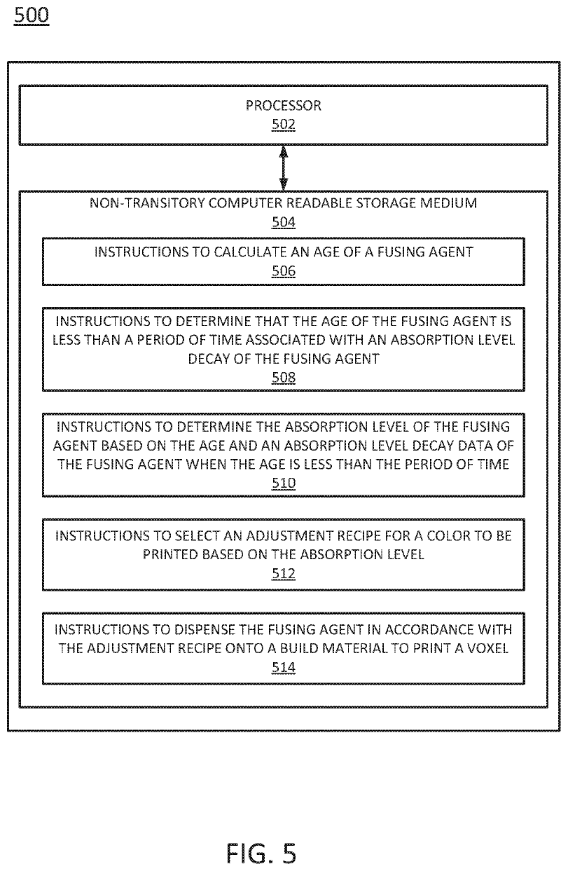

FIG. 4 illustrates a flow diagram of an example method 400 for adjusting an amount of color agents based on an age of a fusing agent. In an example, the method 400 may be performed by the three-dimensional printer 100, the apparatus 200, or the apparatus 500 illustrated in FIG. 5 and described below.

At block 402, the method 400 begins. At block 404, the method 400 calculates an age of a fusing agent. In one example, the date and time of when a new supply of fusing agent is provided may be recorded and stored in memory. The age of the fusing agent may be calculated based on the date and time. For example, a timer may be used to track the age of the date and time or the age may be calculated based on a current date and time relative to the date and time when the new supply of fusing agent was provided.

At block 406, the method 400 determines an absorption level of the fusing agent based on the age and an absorption level decay data of the fusing agent. In one example, the absorption level decay data for the particular fusing agent being used may be generated and stored before the 3D printer is deployed. In one example, based on the age, the corresponding absorption level of the fusing agent may be determined using the absorption level decay data.

At block 408, the method 400 selects an adjustment recipe for a color to be printed based on the absorption level. The adjustment recipe may adjust an amount of the fusing agent to be dispensed, an amount of color agents to be dispensed, or a combination thereof. In one example, the adjustment recipe may adjust the amount of fusing agent. For example, for a certain temperature range, the amount of fusing agent can be increased up to a fusing agent amount threshold to compensate for the absorption level decay of the aging fusing agent.

As noted above, adding too much fusing agent can have cooling effect on the build material and prevent the fusing agent from reaching fusing temperatures. The fusing agent amount threshold may be set to a volume level or fill percentage of the fusing agent that corresponds to a point where the fusing temperature begins to fall off.

In one example, when the amount of fusing agent that is to be added is above the fusing agent amount threshold and the age of the fusing agent is below an age threshold, the adjustment recipe may adjust an amount of color agents that are dispensed. As discussed above, the adjustment recipe may adjust an amount for each different color agent that can be dispensed.

In some examples, the adjustment recipe may be interpolated based on an adjustment recipe of a color that is closest to a color to be printed if adjustment recipes for all colors are not available. For example, the exact adjustment recipe for a color may not be available. A closest adjustment recipe that is stored in memory may be identified. Values for the adjustment of each color agent to be dispensed may be interpolated to generate the adjustment recipe for the color to be printed.

In one example, if the fusing agent is past the age threshold, no adjustment recipe may be used. For example, the absorption level decay of the fusing agent may level off after a certain age (e.g., after the age of the age threshold). Thus, adjustments to the amount of fusing agent and/or color agents may not be used. Rather, a set amount of fusing agent and/or color agents may be dispensed when the age of the fusing agent is above the age threshold.

In one example, the adjustment recipe for each color of each voxel to be printed may be generated before the 3D object is printed. In one example, the adjustment recipe for each color of each voxel to be printed may be selected as the 3D object is being printed. In other words, the blocks 406 and 408 may be repeated for each voxel as the 3D object is being printed.

At block 410, the method 400 controls a dispense element to dispense the fusing agent onto a layer of build material formed in a three-dimensional printer in accordance with the adjustment recipe, data derived from a three-dimensional object model, and the color to be printed at a location. For example, the adjustment recipe may adjust an amount of the fusing agent that is dispensed. Said another way, the adjustment recipe may adjust an amount of fusing agent that would have been dispensed based on the data for the 3D object model to be printed and a color to be printed at a particular location before compensating for the reduction in absorption level of the fusing agent. In one example, the amount of adjustment may be a difference between the calculated amount of fusing agent to be dispensed and the amount of fusing agent to be dispensed when the age of the fusing agent is above the age threshold (e.g., when the absorption level decay begins to level off).

In one example, the dispense element may also be controlled to dispense the color agents based on the adjustment recipe. As noted above, in some instances, the amount of color agents that are dispensed may be adjusted if the amount of fusing agent is too large to compensate for the absorption level decay of the fusing agent. At block 412, the method 400 ends.

FIG. 5 illustrates an example of an apparatus 500. In one example, the apparatus 500 may be the 3D printer 100 or the apparatus 200. In one example, the apparatus 500 may include a processor 502 and a non-transitory computer readable storage medium 504. The non-transitory computer readable storage medium 504 may include instructions 506, 508, 510, 512, and 514 that, when executed by the processor 502, cause the processor 502 to perform various functions to adjusting an amount of color agents based on an age of a fusing agent.

In one example, the instructions 506 may include instructions to calculate an age of a fusing agent. The instructions 508 may include instructions to determine that the age of the fusing agent is less than a period of time associated with an absorption level decay of the fusing agent. The instructions 510 may include instructions to determine the absorption level of the fusing agent based on the age and an absorption level decay data of the fusing agent when the age is less than the period of time. The instructions 512 may include instructions to select an adjustment recipe for a color to be printed based on the absorption level. The instructions 514 may include instructions to dispense the fusing agent in accordance with the adjustment recipe onto a build material to print a voxel.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a dispense element to dispense a fusing agent onto a build material;
a memory to store an absorption level decay data of the fusing agent and at least one adjustment recipe; and
a processor communicatively coupled to dispense element and the memory, the processor to control the dispense element to dispense the fusing agent based on an adjustment recipe of the at least one adjustment recipe that is selected based on an absorption level determined from the absorption level decay data and an age of the fusing agent.

2. The apparatus of claim 1, further comprising a color agent dispense element is to dispense a plurality of color agents.

3. The apparatus of claim 2, wherein the adjustment recipes comprise an adjustment recipe for each printable color.

4. The apparatus of claim 2, wherein the adjustment recipes comprise an adjustment recipe for a subset of printable colors.

5. The apparatus of claim 1, wherein the processor is to select the adjustment recipe for each color of each voxel that is printed.

6. The apparatus of claim 5, wherein the processor is to perform selection of the adjustment recipe for each color of each voxel location before the printing process begins.

7. The apparatus of claim 1, wherein the processor is to control dispensing of the fusing agent also based on data derived from a three-dimensional object model and a color to be printed at a location.

8. A method, comprising:
calculate, by a processor, an age of a fusing agent;
determining, by the processor, an absorption level of the fusing agent based on the age and an absorption level decay data of the fusing agent;
selecting, by the processor, an adjustment recipe for a color to be printed based on the absorption level; and
controlling, by the processor, a dispense element to dispense the fusing agent onto a layer of build material formed in a three dimensional printer in accordance with the adjustment recipe, data derived from a three-dimensional object model, and the color to be printed at a location.

9. The method of claim 8, wherein the adjustment recipe adjusts an amount of color agents that are dispensed onto the layer of build material when the age of the fusing agent is below an age threshold and an adjustment amount of the fusing agent is above a fusing agent amount threshold.

10. The method of claim 9, wherein the selecting comprise:
determining that an exact adjustment recipe for the amount of color agents to be dispensed to generate the color is not available;
identifying a closest adjustment recipe based on a closest color to the color to be printed that is stored in memory; and
interpolating values for the adjustment of each one of the color agents to generate the adjustment recipe for the color to be printed.

11. The method of claim 10, wherein the amount of the color agents is adjusted by increasing or decreasing an amount of a color agent that is dispensed.

12. A non-transitory machine-readable storage medium encoded with instructions executable by a processor, the machine-readable storage medium comprising:
instructions to calculate an age of a fusing agent;
instructions to determine that the age of the fusing agent is less than a period of time associated with an absorption level decay of the fusing agent;
instructions to determine the absorption level of the fusing agent based on the age and an absorption level decay data of the fusing agent when the age is less than the period of time;
instructions to select an adjustment recipe for a color to be printed based on the absorption level; and
instructions to dispense the fusing agent in accordance with the adjustment recipe onto a build material to print a voxel.

13. The non-transitory machine-readable storage medium of claim 12, wherein the instructions to determine the absorption level, the instructions to select, and the instructions to dispense are repeated for each voxel until printing of a three-dimensional object is completed.

14. The non-transitory machine-readable storage medium of claim 12, wherein the adjustment recipes comprise an adjustment to an amount of a cyan color agent, a yellow color agent, a magenta color agent, and a black color agent that are also dispensed with the fusing agent.

15. The non-transitory machine-readable storage medium of claim 12, wherein the instructions to calculate is performed when a new supply of the fusing agent is installed.
